(19) United States
(12) Patent Application Publication
(10) Pub. No.: US 2011/0245449 A1
(43) Pub. Date: Oct. 6, 2011

(54) MELT ADHESIVES CONTAINING THERMOPLASTIC POLYURETHANES

(75) Inventors: Marine BOUDOU, Mannheim (DE); Oliver Steffen Henze, Damme (DE); Dirk Kempfert, Stemwede-Dielingen (DE)

(73) Assignee: BASF SE, Ludwigshafen (DE)

(21) Appl. No.: 13/073,430

(22) Filed: Mar. 28, 2011

Related U.S. Application Data
(60) Provisional application No. 61/318,414, filed on Mar. 29, 2010.

(51) Int. Cl. C08G 18/24; B32B 37/12; B32B 37/14

(52) U.S. Cl. 528/58; 156/331.7

(57) ABSTRACT

The invention relates to an improved method of melt adhesive bonding on the basis of a thermoplastic polyurethane using a thermoplastic polyurethane (TPU) obtainable from essentially a symmetrical aliphatic diisocyanate A and at least one isocyanate-reactive compound B comprising hydroxyl and/or amino groups as an adhesive, wherein the number-average molecular weight (Mn) of compound B is at least 2200 g/mol, with the proviso that it is at least 950 g/mol if compound B is a sebacic ester, diisocyanate A and at least one isocyanate-reactive compound B are reacted in the presence of a catalyst for the polyaddition reaction, the TPU comprises no chain extender, the TPU has an index IN of less than 1000, preferably of less than 990, and more preferably of less than 980, and melt adhesive bonding by the TPU in melt state takes place at a temperature from 50° C. to 160° C. in the absence of solvents, and to substrates bonded therewith.

The invention relates to an improved method of melt adhesive bonding on the basis of a thermoplastic polyurethane (TPU), and to substrates bonded therewith.

Using thermoplastic polyurethanes as hotmelt adhesives is already known. Hotmelt adhesives enable joining techniques with solvent-free, 100% solids adhesive systems, whose use necessitates neither a solvent recovery installation nor the evaporation of water as when using adhesive systems which are water-based. Hotmelt adhesives are applied in the form of hot melts, solidify rapidly on cooling, and thereby build up their strength.

From DE-B 1256822 it is already known to use melts or solutions of reaction products of diisocyanates and esterification products formed from alkanedicarboxylic acids as adhesives for the bonding of polyvinyl chloride polymers. DE-A 1930336 and DE 37 17 070 A1 have already disclosed the use as solvent-borne adhesives of polyester polyurethanes which contain terminal hydroxyl groups and are obtainable through the reaction of polyesterdiols, chain extenders, and an organic diisocyanate. DE 40 35 280 A1 discloses crystalline hotmelt adhesives that comprise isocyanate groups and are based on prepolymers. Like other reactive hotmelt adhesives with terminal isocyanate groups, of the kind described, for example, in DE 101 63 857 A1, DE 197 00 014 A1, and DE 195 19 391 A1, they have the disadvantage that they react with moisture and therefore generate bubbles, which for many purposes are unacceptable, and have very long reaction times, and require high temperatures in the course of preparation.

The TPU-based hotmelt adhesives used in the art are generally segmented and contain so-called hard and soft segments. The hard segments are obtained by reaction of the diisocyanates with low molecular weight chain extenders, the soft segments by reaction of the diisocyanates with, for example, polyols or polyamines having a molecular weight preferably of more than 499 g/mol. Disadvantages of such hotmelt adhesives are their processing temperature of more than 160° C. and their correspondingly high melt viscosities.

It is already known per se to prepare segmented TPUs without chain extenders—see Iskender and Yilgor in: Polymer Reviews, 47:487 to 510, 2007. According to US 2005/0288476 A1, segmented thermoplastic polyurethanes are obtainable by stoichiometric reaction of hydroxyl or amine blocked polymers or oligomers, as soft segments, with diisocyanates, in the absence of chain extenders. These TPUs contain what are called monodisperse hard segments, and are said to be processable in the melt. Their use as hotmelt adhesives, however, is not suggested.

The TPU-based hotmelt adhesives used in the art, which can be prepared in a reaction extruder, generally have a high melting point (i.e., higher than 160° C.), which makes handling difficult.

It is an object of the present invention to provide an improved method of melt adhesive bonding which can be carried out at a low melting temperature and at low melt viscosity, with a hotmelt adhesive which is easy and quick to prepare, and also bonds rapidly and with a low bubble count, in order thereby to save on energy and to allow high productivity for the customer, with an exacting requirement imposed on the mechanical strength at the same time.

The invention provides a method of melt adhesive bonding using a thermoplastic polyurethane (TPU) obtainable from essentially a symmetrical aliphatic diisocyanate A and at least one isocyanate-reactive compound B comprising hydroxyl and/or amino groups as an adhesive, wherein
the number-average molecular weight (Mn) of compound B is at least 2200 g/mol, with the proviso that it is at least 950 g/mol if compound B is a sebacic ester,
diisocyanate A and isocyanate-reactive compound B are reacted in the presence of a catalyst for the polyaddition reaction,
the TPU comprises no chain extender,
the TPU has an index IN of less than 1000, and
melt adhesive bonding by the TPU in melt state takes place at a temperature from 50° C. to 160° C. in the absence of solvents.

The method takes place in the absence of solvents, with solvents meaning substances which dissolve the TPU, more particularly dimethylformamide, methyl ethyl ketone, ethyl acetate, acetones, methylene chloride or tetrahydrofuran.

The TPU used in accordance with the invention comprises no chain extenders, with chain extenders meaning compounds which have at least two isocyanate-reactive groups, more particularly hydroxyl groups or amino groups, and with such compounds having a molecular weight of 499 g/mol or less. In particular there are no typical chain extenders present in the TPU, such as linear alkanediols having two or more carbon atoms such as butane-1,4-diol and hexane-1,6-diol.

Advantages of the invention which are particularly pronounced in the case of preferred embodiments are the use of inexpensive thermoplastic polyurethane, which can be prepared in one process step in an extruder. This material has the advantage that it cures rapidly as a result of shorter crystallization times, preferably in less than 1 hour, and therefore also allows more rapid hot bonding. Moreover, both during preparation and also, in particular, during hot bonding, lower temperatures are needed, and these temperatures allow greater ease of handling and also provide for a not inconsiderable energy saving on extensive application.

In one particularly preferred embodiment the thermoplastic polyurethane has an index from 850 to 999, preferably from 850 to 990, and more preferably from 850 to 980.

The index is defined by the molar ratio of the total isocyanate groups of component A that are used in the reaction to the isocyanate-reactive groups, i.e., the active hydrogens, of components B. With an index of 1000, for each isocyanate group of component A there is one active hydrogen atom, i.e., one isocyanate-reactive function, of components (B). With indices below 1000, there are fewer isocyanate groups than groups having active hydrogen atoms, e.g., OH groups.

The index is calculated by the formula

$$IN = \frac{{n}_{ISO}}{{n}_{OH}} = \frac{{f}_{ISO 1} {n}_{ISO 1}}{{f}_{P 1} {n}_{P 1}} \times 1000 \qquad FORMULA 1$$

in which
IN: index
n_{ISO}: total molar fraction of NCO-containing molecules, in mol
n_{OH}: total molar fraction of active hydrogen, particularly of OH-containing molecules (polyols), in mol
f_{IOS1}: functionality of isocyanate 1
n_{ISO1}: molar fraction of isocyanate 1
f_{P1}: functionality of polyol 1
n_{P1}: molar fraction of polyol 1

Polyurethane preparation processes are general knowledge. For example, the polyurethanes may be prepared by reaction of isocyanates with isocyanate-reactive compounds in the presence of catalysts and, optionally, of customary auxiliaries.

The starting components and processes for preparing the preferred polyurethanes are set out by way of example below. Described by way of example below are the components that are typically used in preparing the polyurethanes: Isocyanates A, isocyanate-reactive compound (B), and also, optionally, catalysts D, which accelerate the reaction between the NCO groups of the diisocyanates A and the hydroxyl groups of the synthesis components B, also addressed as polyol, and/or auxiliaries E.

The isocyanates A and the isocyanate-reactive compounds (polyols) B are also referred to as synthesis components.

Components for use in accordance with the invention:

As organic isocyanates (A) symmetrical aliphatic isocyanates that are common knowledge are used, preferably diisocyanates, examples being tri-, tetra-, penta-, hexa-, hepta- and/or octamethylene diisocyanate, 1,4- and/or 1,3-bis(isocyanatomethyl)-cyclohexane (HXDI), 1,4-cyclohexane diisocyanate, 4,4′-, 2,4′-, and 2,2′-dicyclohexyl-methane diisocyanate (H12MDI), preferably hexamethylene diisocyanate (HDI), 4,4′-, 2,4′- and 2,2′-dicyclohexylmethane diisocyanate (H12MDI), more particularly hexamethylene diisocyanate.

A symmetrical isocyanate is understood to be an isocyanate, or in the case of an isomer mixture the majority isomer, which is a symmetrical molecule and has two isocyanate groups of equal reactivity.

The method of the invention uses essentially an isocyanate. Essentially a TPU here means that as well as the essential isocyanate other isocyanates, based on the isocyanate with less than 5%, more preferably less than 3% and with particular preference less than 1%, by weight, are used. Not included in this are oligomers resulting from addition reaction of an isocyanate; these products are included in the essentially an isocyanate.

As isocyanate-reactive compounds (B) it is possible to use isocyanate-reactive compounds that are common knowledge and comprise preferably hydroxyl and/or amino groups, the number-average molecular weight (Mn) of the compound B being at least 2200 g/mol, with the proviso that it is at least 950 g/mol if the compound B is an ester of sebacic acid. Preference is given to polyesterols, polyetherols and/or polycarbonatediols, commonly also referred to collectively as “polyols”. The isocyanate-reactive compounds have a number-average molecular weight (Mn) of not more than 12 000 g/mol, preferably not more than 6000, more particularly not more than 4000, and preferably having an average functionality of 1.8 to 2.3, preferably 1.9 to 2.2, more particularly 2.

All limiting values indicated in the description can be combined arbitrarily with all other limiting values, although, for reasons of clarity, not every individual combination is recited.

A preferred isocyanate-reactive compound (B) is polyesterdiol.

One further preferred embodiment uses as isocyanate-reactive compound (B) a polyesterdiol, based more particularly on butanediol and adipic acid, having a number-average molecular weight (Mn) of at least 2200 g/mol, in a blend with a polyetherdiol.

The polyetherdiol in this blend may have a number-average molecular weight (Mn) of less than 2200 g/mol; the number-average molecular weight of the polyetherdiol used for blending is preferably at least 500 g/mol, more particularly at least 650 g/mol. In one particularly preferred embodiment the polyetherdiol used for blending is a polytetramethylene glycol. In one particularly preferred embodiment this blend uses 0.05 to 1 part by weight of polyetherdiol to one part by weight of polyesterdiol.

In another preferred embodiment, an ester of sebacic acid is used as isocyanate-reactive compound (B), the ester of sebacic acid being based more preferably on butanediol and having a number-average molecular weight (Mn) of at least 950 g/mol.

Suitable catalysts (D) which accelerate the reaction between the NCO groups of the diisocyanates (A) and the hydroxyl groups of the formative components (B) are the customary tertiary amines known from the prior art, e.g. triethylamine, dimethyl-cyclohexylamine, N-methylmorpholine, N,N′-dimethylpiperazine, 2-(dimethylamino-ethoxy)ethanol, diazabicyclo[2.2.2]octane and the like, and also, in particular, organic metal compounds such as titanic esters, iron compounds, preferably iron(III) acetylacetonate, tin compounds, preferably tin diacetate, tin dioctoate, tin dilaurate or the dialkyltin salts of aliphatic carboxylic acids, preferably dibutyltin diacetate, dibutyltin dilaurate or the like. Iron compounds are particularly preferred. The catalysts are preferably used in amounts from 0.00001 to 0.1 part by weight per 100 parts by weight of polyhydroxyl compound (B).

Apart from catalysts (D), customary auxiliaries (E) can also be added to the formative components (A) to (B). Examples include surface-active substances, flame retardants, nucleating agents, oxidation stabilizers, lubricants and mold release agents, dyes and pigments, stabilizers, e.g. against hydrolysis, light, heat or discoloration, inorganic and/or organic fillers, reinforcing materials, and plasticizers.

As hydrolysis inhibitors, preference is given to using oligomeric and/or polymeric aliphatic or aromatic carbodiimides. To stabilize the TPUs of the invention against aging, stabilizers are preferably added to the TPU. For the purposes of the present invention, stabilizers are additives which protect a polymer or a polymer mixture against damaging environmental influences. Examples are primary and secondary antioxidants, hindered amine light stabilizers, UV absorbers, hydrolysis inhibitors, quenchers, and flame retardants. Examples of commercial stabilizers are given in Plastics Additive Handbook, 5th edition, H. Zweifel, ed., Hanser Publishers, Munich, 2001 ([1]), p. 98-p. 136. If the TPU of the invention is exposed to thermooxidative damage during use, antioxidants can be added. Preference is given to using phenolic antioxidants. Examples of phenolic antioxidants are given in Plastics Additive Handbook, 5th edition, H. Zweifel, ed. Hanser Publishers, Munich, 2001, pp. 98-107 and pp. 116-121. Preference is given to using phenolic antioxidants whose number-average molecular weight (Mn) is greater than 700 g/mol. An example of a phenolic antioxidant which is preferably used is pentaerythrityl tetrakis (3-(3,5-bis(1,1-dimethylethyl)-4-hydroxyphenyl)propionate) (Irganox® 1010). The phenolic antioxidants are generally used in concentrations between 0.1% and 5% by weight, preferably between 0.1% and 2% by weight, more particularly between 0.5% and 1.5% by weight, based in each case on the total weight of the TPU.

The TPUs are preferably additionally stabilized by means of a UV absorber. UV absorbers are molecules which absorb high-energy UV light and dissipate the energy. Customary UV absorbers which are used in industry belong, for example, to the group of cinnamic esters, diphenyl cyanoacrylates, formamidines, benzylidenemalonates, diarylbutadienes, triazines, and benzotriazoles. Examples of commercial UV absorbers may be found in Plastics Additive Handbook, 5th edition, H. Zweifel, ed, Hanser Publishers, Munich, 2001, pages 116-122. In a preferred embodiment, the UV absorbers have a number-average molecular weight (Mn) of greater than 300 g/mol, in particular greater than 390 g/mol. Furthermore, the UV absorbers which are preferably used should have a number-average molecular weight (Mn) of not greater than 5000 g/mol, preferably not greater than 2000 g/mol. The group of benzotriazoles is particularly useful as UV absorbers. Examples of particularly suitable benzotriazoles are Tinuvin® 213, Tinuvin® 328, Tinuvin® 571 and Tinuvin® 384, and Eversorb® 82. The UV absorbers are preferably metered in amounts between 0.01% and 5% by weight, based on the total mass of TPU, more preferably between 0.1% and 2.0% by weight, in particular between 0.2% and 0.5% by weight, based in each case on the total weight of the TPU. UV stabilization as described above based on an antioxidant and a UV absorber is often still insufficient to ensure good stability of the TPU of the invention against the damaging influence of UV rays. In this case, a hindered amine light stabilizer (HALS) can be added to the component (E) to give the TPU of the invention, preferably in addition to the antioxidant and the UV absorber. The activity of the HALS compounds is based on their ability to form nitroxyl radicals which intervene in the mechanism of oxidation of polymers. HALSs are highly efficient UV stabilizers for most polymers. HALS compounds are generally known and are commercially available. Examples of commercially available HALS stabilizers may be found in Plastics Additive Handbook, 5th edition, H. Zweifel, Hanser Publishers, Munich, 2001, pp. 123-136. As hindered amine light stabilizers, preference is given to hindered amine light stabilizers which have a number-average molecular weight (Mn) of greater than 500 g/mol. Furthermore, the number-average molecular weight (Mn) of the preferred HALS compounds should preferably be not greater than 10 000 g/mol, particularly preferably not greater than 5000 g/mol. Particularly preferred hindered amine light stabilizers are bis(1,2,2,6,6-pentamethylpiperidyl) sebacate (Tinuvin® 765, Ciba Spezialitatenchemie AG) and the condensation product of 1-hydroxyethyl-2,2,6,6-tetramethyl-4-hydroxypiperidine and succinic acid (Tinuvin® 622). Very particular preference is given to the condensation product of 1-hydroxyethyl-2,2,6,6-tetramethyl-4-hydroxypiperidine and succinic acid (Tinuvin® 622) when the titanium content of the product is <150 ppm, preferably <50 ppm, in particular <10 ppm. HALS compounds are preferably used in a concentration between 0.01% and 5% by weight, more preferably between 0.1% and 1% by weight, in particular between 0.15% and 0.3% by weight, in each case based on the total weight of the TPU. A particularly preferred UV stabilization comprises a mixture of a phenolic stabilizer, a benzotriazole, and a HALS compound in the above-described preferred amounts.

Further details regarding the abovementioned auxiliaries and additives may be found in the technical literature, e.g. in Plastics Additive Handbook, 5th edition, H. Zweifel, ed, Hanser Publishers, Munich, 2001.

The preparation of the TPUs can be carried out by the known processes, continuously, as for example with reaction extruders, or the belt process by the one-shot process or the prepolymer process, or batchwise by the known prepolymer process. In these processes, the components (A), (B) and, optionally, (D) and/or (E) being reacted can be mixed with one another either in succession or simultaneously, with the reaction starting immediately. In the case of the extruder process, the components (A), (B), (D) and, optionally, (E) are introduced into the extruder either individually or as a mixture, and reacted at temperatures for example from 100° C. to 280° C., preferably 140° C. to 250° C. The melt is pelletized and dried.

In one particularly preferred embodiment the thermoplastic polyurethane is based on a polyester of adipic acid or sebacic acid with butanediol and preferably HDI as polyisocyanate.

The polyurethanes of the invention are employed as hotmelt adhesives at elevated temperature. Preferably the polyurethanes are melted continuously or batchwise at temperatures from 50° C. to 160° C., preferably from 80° C. to 160° C. and in another preferred embodiment from 60° C. to 150° C., and their melt is contacted with the substrates to be bonded. This application to at least one of the surfaces to be bonded may take place, for example, via rolls, nozzles, spinning of the hot melts with a hot stream of air and hotmelt adhesive sheet using a hot press. In one preferred embodiment, application of the hotmelt adhesive is followed immediately by bonding to the substrates to be bonded.

The adhesive is applied, in particular, continuously, and after the hotmelt adhesive has been applied to one of the surfaces to be bonded, that surface is married with the other, optionally preheated, adhesive-bearing or adhesive-free surface, and the assembly is processed further preferably under pressure and with optional shaping.

The substrates to be bonded are preferably textiles, metals, wood, wood products, cork, ceramic, glass, including glass fibers, and also solid or foamed plastics, such as ABS, PVC, polyolefins, polyurethanes, and neoprene, which is a polychloroprene. The TPU of the invention is preferably used for this purpose. Particular preference is given to textiles, glass, polyurethane, and polychloroprene. In this context the hotmelt adhesives of the invention may be used for a very wide variety of fields of use.

In another embodiment the present invention is directed to moldings comprising a thermoplastic polyurethane obtainable from at least one diisocyanate A and at least one isocyanate-reactive compound B, comprising hydroxyl groups and/or amino groups, as hotmelt adhesive, wherein
the number-average molecular weight (Mn) of compound B is at least 2200 g/mol, with the proviso that it is at least 950 g/mol if compound B is a sebacic ester,
diisocyanate A and isocyanate-reactive compound B are reacted in the presence of a catalyst for the polyaddition reaction,
the TPU comprises no chain extender, and
the TPU has an index IN of less than 1000.

Preferred moldings are rollers, footwear soles, trim parts in automobiles, hoses, coatings, cables, profiles, laminates, floors for buildings and transport, plug connections, cable plugs, cushions, bellows, saddles, foams, including by additional foaming, towing cables, solar modules, wiper blades, cable sheathing, seals, belts, nonwoven fabrics, damping elements, sheets or fibers, produced preferably by injection molding, calendering, powder sintering and/or extrusion.

The invention further provides said moldings comprising a melt bond using the TPUs for use in accordance with the invention.

### EXAMPLES

The examples below used the following components:

TABLE 1

| Abbreviation | Composition |
|---|---|
| ISO-1 | 4,4′-MDI |
| ISO-2 | HDI |
| Polyol 1 | Polyesterdiol (butanediol-adipic acid) |
| | having a number-average molecular |
| | weight (Mn) of 2500 g/mol) |
| Polyol 2 | Polyesterdiol (butanediol-sebacic acid) |
| | having a number-average molecular |
| | weight (Mn) of 1000 g/mol) |
| Polyol 3 | Polyesterdiol (butanediol-adipic acid) |
| | having a number-average molecular |
| | weight (Mn) of 1000 g/mol) |
| Polyol 4 | (Polytetramethylene glycol) having a |
| | number-average molecular weight (Mn) of |
| | 650 g/mol |

Using these components, the following comparisons were conducted:

### Example 1

### Comparative

In a 2 L tin pail, 1200 g of polyol 1 were heated to 90° C. Thereafter, with stirring, 100 ppm of tin dioctoate were added. After the solution had been heated to 80° C. again, 289.43 g of ISO-1 were added and the solution was stirred until it was homogeneous. The reaction mass was then poured into a shallow tray. The crystallization time of the resulting sheet was measured by means of a spatula. The sheet was comminuted in a mill and the corresponding melting temperature and crystallization temperature were measured by means of DSC (Differential Scanning Calorimetry) using a Perkin-Elmer DSC 7 (heating/cooling rate 20K/min).

### Example 2

### Comparative

In a 2 L tin pail, 1300 g of polyol 1 were heated to 90° C. Thereafter, with stirring, 100 ppm of tin dioctoate were added. After the solution had been heated to 80° C. again, 127.39 g of ISO-1 were added and the solution was stirred until it was homogeneous. The reaction mass was then poured into a shallow tray. The crystallization time of the resulting sheet was measured by means of a spatula. The sheet was comminuted in a mill and the corresponding melting temperature and crystallization temperature were measured by means of DSC (Differential Scanning calorimetry) using a Perkin-Elmer DSC 7 (heating/cooling rate 20K/min).

### Example 3

### Comparative

In a 2 L tin pail, 1250 g of polyol 3 were heated to 90° C. Thereafter, with stirring, 100 ppm of tin dioctoate were added. After the solution had been heated to 80° C. again, 202.63 g of ISO-2 were added and the solution was stirred until it was homogeneous. The reaction mass was then poured into a shallow tray. The crystallization time of the resulting sheet was measured by means of a spatula. The sheet was comminuted in a mill and the corresponding melting temperature and crystallization temperature were measured by means of DSC (Differential Scanning calorimetry) using a Perkin-Elmer DSC 7 (heating/cooling rate 20K/min).

### Example 4

### Inventive

In a 2 L tin pail, 1350 g of polyol 1 were heated to 90° C. Thereafter, with stirring, 100 ppm of tin dioctoate were added. After the solution had been heated to 80° C. again, 88.91 g of ISO-2 were added and the solution was stirred until it was homogeneous. The reaction mass was then poured into a shallow tray. The crystallization time of the resulting sheet was measured by means of a spatula. The sheet was comminuted in a mill and the corresponding melting temperature and crystallization temperature were measured by means of DSC (Differential Scanning calorimetry) using a Perkin-Elmer DSC 7 (heating/cooling rate 20K/min).

The properties apparent from the table below were ascertained:

TABLE 2

| | | Melting | Crystallization |
|---|---|---|---|
| Example | Crystallization time | temperature | temperature |
| 1 | still tacky after 24 h | — | — |
| 2 | 1 h 40 min. | 60° C. | −7° C. |
| 3 | 35 min. | 92° C. | −16° C. |
| 4 | 35 min. | 63° C. | 7° C. |

Inventive example 4 clearly shows the best combination of very low melting temperature and maximum crystallization temperature, and enables improved preparation of TPU.

### Example 5

### Inventive

A TPU was prepared from ISO-2 and polyol 1 (OHN=46.0) using a tin dioctoate catalyst and a ZSK 58 twin-screw extruder from Werner und Pfleiderer, Stuttgart, having a screw-section length of 48 D, divided into 12 barrels. TPU and polyol were used in a proportion so as to give an index IN of 970. The tin dioctoate was used in an amount of 15 ppm, based on the total mass. For pelletizing, a conventional underwater pelletizer from Gala (UWG) was used. The material was subsequently processed to injection molded plaques (plaque dimensions: 110×25×2). The test plaques were heated at 100° C. for 20 hours and their mechanical properties were ascertained.

### Example 6

### Inventive

A TPU was prepared from ISO-2 and polyol 2 (OHN=112.6) using a tin dioctoate catalyst and a ZSK 58 twin-screw extruder from Werner und Pfleiderer, Stuttgart, having a screw-section length of 48 D, divided into 12 barrels. TPU and polyol were used in a proportion so as to give an index IN of 970. For pelletizing, a conventional underwater pelletizer from Gala (UWG) was used. The material was subsequently processed to injection molded plaques (plaque dimensions: 110×25×2). The test plaques were heated at 100° C. for 20 hours and their mechanical properties were ascertained.

### Example 7

A TPU was prepared from ISO-2, polyol 1 (OHN=46.0) and polyol 4 (OHN=170.1) using a ZSK 58 twin-screw extruder from Werner und Pfleiderer, Stuttgart, having a screw-section length of 48 D, divided into 12 barrels. For each part by weight of polyol 1, 0.57 part by weight of polyol 4 was used. Polyol mixture was used with the isocyanate in a proportion so as to give an index IN of 970. The polyaddition reaction was carried out using a tin dioctoate catalyst, the tin dioctoate being used in an amount of 40 ppm, based on the total mass.

The properties apparent from table 3 below were ascertained:

TABLE 3

| | | | Example | Example | |
|---|---|---|---|---|---|
| | | Testing | 5 | 6 | Example |
| Property | Unit | specification | Inventive | Inventive | 7 |
| Index | | | 970 | 970 | 970 |
| Density | g/cm³ | DIN EN ISO | 1.179 | 1.111 | 1.122 |
| | | 1183-1, B | | | |
| Shore | — | DIN 53 505 | 96 | 96 | 96 |
| hardness A | | | | | |
| Tensile | MPa | DIN 53 504 | 17 | 22 | 10 |
| strength | | | | | |
| Elongation at | % | DIN 53 504 | 770 | 390 | 1060 |
| break | | | | | |
| Tear | kN/m | DIN ISO | 93 | 97 | 44 |
| propagation | | 34-1 | | | |
| resistance | | | | | |
| Abrasion | mm³ | DIN ISO | 99 | 8 | 298 |
| | | 4649 | | | |
| Melting | ° C. | | 68 | 127 | 64 |
| temperature | | | | | |
| Crystallization | ° C. | | 9 | 27 | −15 |
| temperature | | | | | |

From inventive examples 5 to 7 it is apparent that a TPU having good mechanical properties is obtained.

### Example 8

### Application Example

An inventive TPU from example 5 was used to bond a substrate made of waterproof nylon. For this purpose the TPU sheet (100 μm) in the melt state at a temperature of 150° C. was applied between two layers of substrate using a heating press with a pressure of 1 kN for one minute, in the absence of solvents. After the pressing procedure, the specimens were tested for their parting resistance in a usual way using a tensile strength testing machine (from Zwick, model Z 2.5). The specimens were 2.5 cm wide, 20 cm long, and bonded over 12 cm. Of the unbonded 8 cm, 4 cm were clamped into the machine. Measurement took place with a speed of 100 mm/min. The specimens gave very good parting resistance of 13.2 N/mm in conjunction with good processing properties.

1. A method of melt adhesive bonding using a thermoplastic polyurethane (TPU) obtainable from essentially a symmetrical aliphatic diisocyanate A and at least one isocyanate-reactive compound B comprising hydroxyl and/or amino groups as an adhesive, wherein
the number-average molecular weight (Mn) of compound B is at least 2200 g/mol, with the proviso that it is at least 950 g/mol if compound B is a sebacic ester,
diisocyanate A and at least one isocyanate-reactive compound B are reacted in the presence of a catalyst for the polyaddition reaction,
the TPU comprises no chain extender,
the TPU has an index IN of less than 1000, preferably of less than 990, and more preferably of less than 980, and
melt adhesive bonding by the TPU in melt state takes place at a temperature from 50° C. to 160° C. in the absence of solvents.

2. The method according to claim 1, wherein the isocyanate-reactive compound has hydroxyl groups and/or amino groups terminally.

3. The method according to at least one of the preceding claims, wherein the index IN has a value of between 850 and 999, preferably between 850 and 990, and more preferably between 850 and 980.

4. The method according to at least one of the preceding claims, wherein the diisocyanate is a dicyclohexylmethane diisocyanate (H12MDI).

5. The method according to at least one of the preceding claims, wherein the diisocyanate is a hexamethylene diisocyanate (HDI).

6. The method according to at least one of the preceding claims, wherein the catalyst is a tin compound.

7. The method according to at least one of the preceding claims, wherein compound B is a polyester.

8. The method according to claim 7, wherein the polyester has a number-average molecular weight (Mn) of not more than 12 000 g/mol, preferably not more than 6000 g/mol, more particularly not more than 4000 g/mol.

9. The method according to at least one of the preceding claims, wherein compound B is a polyester based on butanediol and adipic acid.

10. The method according to at least one of the preceding claims 1 to 8, wherein compound B is a polyester based on butanediol and sebacic acid.

11. The method according to at least one of the claims, wherein compound B is a polyester and additionally a polyetherol is used.

12. The method according to at least one of the preceding claims, wherein the TPU is used to bond textiles, metals, wood, wood products, cork, ceramic, glass, including glass fibers, and also solid or foamed plastics.

13. A film, injection molding or extruded article comprising a thermoplastic polyurethane obtainable from essentially a symmetrical aliphatic diisocyanate A and at least one isocyanate-reactive compound B comprising hydroxyl groups and/or amino groups, as hotmelt adhesive, wherein
the number-average molecular weight (Mn) of compound B is at least 2200 g/mol, with the proviso that it is at least 950 g/mol if compound B is a sebacic ester,
diisocyanate A and isocyanate-reactive compound B are reacted in the presence of a catalyst for the polyaddition reaction,
the TPU comprises no chain extender, and
the TPU has an index IN of less than 1000.

14. A film, injection molding or extruded article comprising a melt bond using a thermoplastic polyurethane according to at least one of the preceding claims.
